(19) United States
(12) Patent Application Publication
(10) Pub. No.: US 2015/0325869 A1
(43) Pub. Date: Nov. 12, 2015

(54) Humidifier, for Example, for a Fuel Cell

(71) Applicant: MANN+HUMMEL GMBH, Ludwigsburg (DE)

(72) Inventors: Michael Fasold, Auenwald (DE); Ralf Werner, Steinach (DE); Egon Ellmer, Foeritz (DE); Mathias Weiss, Sonneberg (DE); Michael Maier, Reisbach (DE); Patricie Merkert, Kirchheim (DE); Dirk Eberspaecher, Waiblingen (DE); Peter Muench, Tamm (DE); Andreas Kloz, Bietigheim-Bissingen (DE); Thomas Tschech, Marbach (DE); Oliver Wiesner, Steinheim (DE); Andreas Epp, Marbach (DE); Reiner Bulling, Ingersheim (DE); Volker Kuemmerling, Bietigheim-Bissingen (DE); Marcel Mayer, Stuttgart (DE)

(21) Appl. No.: 14/702,064

(22) Filed: May 1, 2015

(30) Foreign Application Priority Data
May 6, 2014 (DE) 10 2014 006 464.6

(51) Int. Cl. H01M 8/04; B01F 3/04

(52) U.S. Cl. CPC H01M 8/04291; B01F 3/04; B01F 2215/0098

(57) ABSTRACT

A humidifier is provided with a housing and at least one water-permeable membrane arranged in the housing and provided with first and second opposed sides. A first gas stream having a first moisture contents is guided on the first opposed side and a second gas stream having a second moisture contents is guided on the second opposed side through the humidifier. The first moisture contents is higher than the second moisture contents. The at least one water-permeable membrane is folded and has folds.

### BACKGROUND OF THE INVENTION

The invention concerns a humidifier, for example, for a fuel-cell, comprising at least one water-permeable membrane arranged in a housing across which a gas stream with higher moisture contents and a gas stream with lower moisture contents are guided on opposed sides.

Known humidifiers for fuel cells, disclosed, for example, in DE 10 2009 034 095 A1 or EP 1 261 992 B1, comprise several membranes which are lying in parallel planes and separate intermediately positioned flow channels through which moist or dry air is guided. Water molecules pass through each membrane from the moist to the dry air stream which is enriched thereby with moisture. The humidified air stream is supplied to a fuel cell system in which electric current is produced by an electrochemical reaction.

According to DE 10 2009 034 095 A1, several membranes lying above each other are combined in a stack. The membranes are connected at their edge area by frame parts of a housing wherein between the frame parts of neighboring membranes a sealing element for a flow-tight closure are arranged. Flow channels, which are positioned above each other and between which a membrane is arranged, respectively, are flowed through in cross-flow by the dry or moist air. The frame parts and the intermediately positioned sealing elements serve at the same time as spacers in order to secure the clamped parallel membranes at a spacing to each other.

### SUMMARY OF THE INVENTION

It is the object of the invention to provide a simple humidifier of compact configuration which comprises a plurality of flow channels which are flowed through by a dry or moist gas stream.

This object is solved according to the invention in that the membrane is embodied in a folded shape. The dependent claims provide expedient further embodiments.

The humidifier according to the invention enables enrichment of flowing air with moisture so that a required minimum moisture contents is achieved in the air stream. The humidifier is employed, for example, for fuel cells in which electric current is generated by an electrochemical reaction. In this context, the air that is enriched with moisture is supplied to the inlet of the fuel cell. At the outlet side, the exhaust air with a relatively high moisture contents leaves the fuel cell; the exhaust air is introduced into the humidifier where the moisture is transferred through the membranes to the supplied fresh air stream.

Moreover, use of the humidifier in other technical fields is possible also. For example, the humidifier can be employed for humidifying the breathing air in closed chambers or cabins, for example, in airplanes.

The humidifier comprises at least one water-permeable membrane which is received in a housing. A gas stream is guided across the opposed sides of the membrane, respectively, wherein the gas streams have a differently high moisture contents. Through the membrane, water passes from the first gas stream with higher moisture contents to the second gas stream with lower moisture contents.

In the humidifier according to the invention, the membrane is arranged in a folded shape in the housing. The various folds of the membrane separate the flow channels for the gas streams with higher and lower moisture contents, wherein the moisture contents is at least partially compensated through the membranes. The membrane can be laid into several folds which provides for a significant constructive simplification in comparison to conventional humidifiers with a stacked unit with several membranes that are arranged in parallel planes, respectively. In the embodiment according to the invention, a single membrane is in principle sufficient for the humidifier which however may be optionally laid into a plurality of individual folds. However, it is also possible to employ several membranes in different humidifiers which either adjoin each other immediately or, like a stacked unit, are arranged on top of each other.

It may be expedient to insert spacers into the folds of the membrane which stabilize the folds and prevent collapse of the folds. In particular in case of a pressure differential between the gas streams with higher and lower moisture contents, the spacers serve for stabilizing the folds. In this context, it may however be sufficient to insert the spacers only into the folds of the gas stream with lower pressure because collapse of the folds in the other gas stream is prevented by the higher pressure.

The spacers extend advantageously across the length of the folds. They are designed, for example, as a rectangular insertion part that is secured on a base plate. The base plate may accommodate a plurality of such insertion parts which each project into a fold of the membrane, respectively. The spacers are advantageously embodied separate from the base plate and are inserted into the base plate. Optionally, insertion openings are introduced into the base plate by means of which the spacers can be inserted into their mounted position at the base plate. It may be expedient to guide only some of the spacers through such insertion openings and to insert the remaining spacers from the opposite direction into the base plate. For example, an insertion opening is introduced into the base plate for every other spacer.

According to a further expedient embodiment, the spacer elements have a base support that can be embodied optionally as a plate and is a carrier for transverse profiles that determine the fold width. The base support extends preferably across the fold length, the transverse profiles can be arranged at various positions along the height of the base support and, depending on the height position, can have a different width. In this way, the tapering fold width in the direction toward the fold base can be taken into account.

The gas stream along the fold into which a spacer has been inserted can be guided along both sides of the base plate. The transverse profiles that support the membrane can form in this context a meander-shaped flow channel along the base support through which the gas is guided. The meander structure of the flow channel at one side, or optionally at both sides, of the base support ensures for the desired moisture exchange a sufficiently long contact of the gas stream, guided through the flow channel, with the membrane.

In the area of the end face, the spacers, in particular the base support, can comprise a sealing element which either is injection-molded onto the spacer or connected to the spacer in other ways. The sealing element ensures a flow-tight connection between the end face edge of the spacer and a housing receptacle of the humidifier. Optionally, the sealing element at the spacer interacts with a further sealing element on the housing, for example, in accordance with a labyrinth seal.

For supporting the membrane that is comprised of a very thin material, on at least one side of the membrane a support grid is advantageously resting that, for example, is comprised of plastic material or metal and extends at least approximately, preferably completely, across the surface of the membrane on one side. The flow openings in the support grid permit a satisfactory flow exchange between different sides of the membrane. The membrane and the support grid can be connected to each other. Optionally, the membrane is resting only loosely on the support grid. Embodiments are possible in which only on one side of the membrane a support grid is provided as well as embodiments with support grids on both sides of the membrane.

According to a further expedient embodiment, sealing elements are arranged on the end faces of the membrane. By means of these sealing elements that extend along the end face edges of the folds of the membrane, leakage flows between the opposed sides of the membranes are prevented. The sealing elements are produced by injection molding or potting a sealing material, for example, a plastic material, about the exterior edge of the membrane in order to obtain a sealing action.

During manufacture, the two thin layers between which the membrane is positioned are used, for example, for sealing within the tool in that they are compressed and in this way a tolerance-insensitive sealing strip is produced wherein the layers are compressed to a reduced thickness. In this way, the complete frame can be applied by injection molding. Optionally, at the end face gas passages are introduced into the sealing elements whereby the gas guiding action, at least on one folded side, is simplified because flow is possible axially in or out of the fold.

For edge-side sealing of the membrane, it is also possible that two comb-shaped lateral frame parts mesh with each other.

### BRIEF DESCRIPTION OF THE DRAWINGS

Further advantages and expedient embodiments can be taken from the claims, the figure description, and the drawings.

FIG. 1 shows a humidifier, for example, for a fuel-cell, comprising a housing in which a water-permeable folded membrane is received, wherein into the folds of the membrane plate-shaped spacers are inserted.

FIG. 2 is a section through the humidifier transverse to the longitudinal plane of the spacers.

FIG. 3 is a section through the humidifier along the longitudinal plane of a spacer.

FIG. 4 is a section according to FIG. 2, but in an enlarged illustration.

FIG. 5 is a view of a spacer with a meander-shaped flow guiding action for a gas stream.

FIG. 6 shows the spacers secured on a base plate in an end view.

FIG. 7 shows the spacers secured on the base plate in a perspective view.

FIG. 8 is a plan view onto a spacer.

FIG. 9 is an end face view of a spacer.

FIG. 10 is a section through the edge area with comb-shaped meshing frame parts for fixation of the membrane.

FIG. 11 shows a base plate with an insertion opening for inserting a spacer.

In the figures, same components are provided with same reference characters.

### DESCRIPTION OF PREFERRED EMBODIMENTS

In the figures, a humidifier 1 is illustrated with which, for example, the supply air for a fuel cell can be enriched with moisture. The humidifier 1 is designed as a moisture exchanger in which a first gas stream with high moisture contents is introduced into the housing 2 of the humidifier 1 or discharged from it according to arrows 5 and, at the same time, a second gas stream 6 with low moisture contents is also passed through the housing 2 perpendicular thereto. In the housing 2, a fold-shaped membrane which is embodied to be water-permeable is provided wherein the gas stream 5 with high moisture contents is guided on one side of the membrane and the gas stream 6 with low moisture contents is guided on the opposed side of the membrane. Through the membrane, a moisture exchange from the moist gas stream 5 to the gas stream 6 with low moisture contents takes place so that the gas stream 6 is enriched with moisture. The gas stream 5 is, for example, the exhaust gas stream of the fuel cell that has a relatively high moisture contents and the gas stream 6 is a fresh air stream with lower moisture contents taken in from the environment that is supplied as the input stream of the fuel cell and is to be adjusted to a defined higher moisture contents.

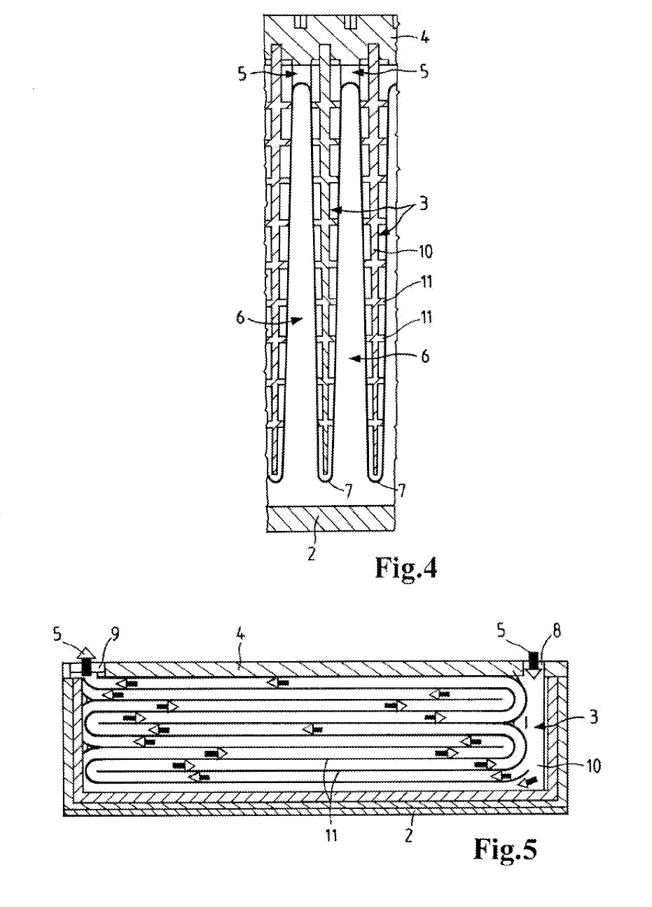

A plurality of spacers 3 that are plate-shaped and extend parallel to each other is introduced into the housing 2. The plate-shaped spacers 3, as can be seen in the enlarged illustration according to FIG. 4, project into every other fold of the membrane 7. Each spacer 3 is secured on a base plate 4 which is part of the housing 2. The spacers 3 are located in those folds which are flowed through by the moist gas stream 5 which is the exhaust gas stream of the fuel cell. Since the exhaust gas stream 5 has a pressure that is reduced compared to the fresh air stream 6, supporting the folds of the membrane 7 on the side with reduced pressure is sufficient. In contrast to this, at the fresh air side which exhibits a higher pressure, no support of the folds of the membrane 7 is required.

For stabilizing the membrane, at one side, or optionally on both sides, of the membrane a support grid of plastic or metal can be arranged, respectively, that extends at least substantially across the entire surface of the membrane and is embodied in a folded shape in the same way as the membrane.

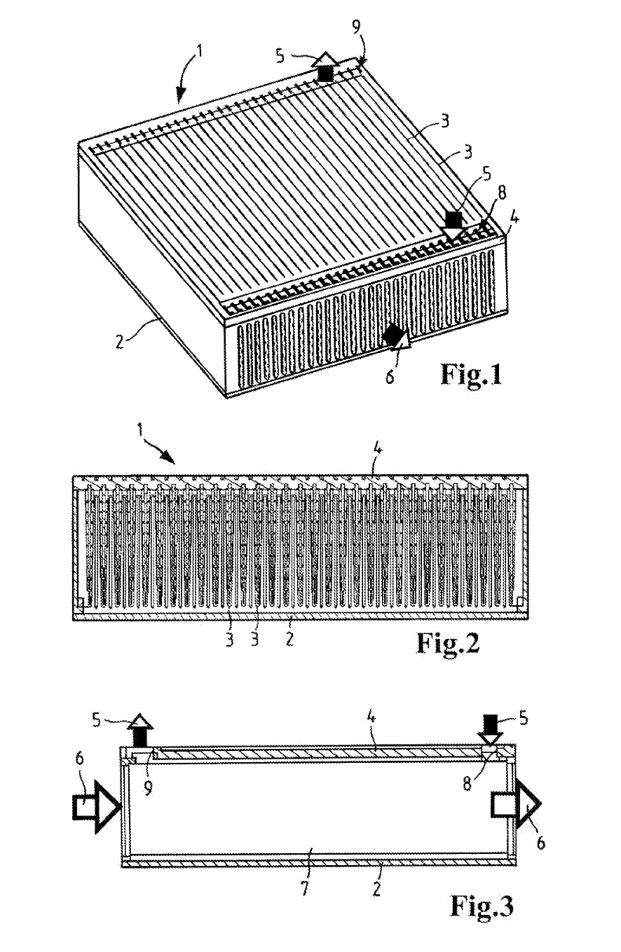

As can be seen in FIG. 1 in connection with FIGS. 3 and 5, flow openings 8 and 9 are introduced into the base plate 4 of the housing 2 and extend across the width of the base plate 4; the exhaust gas flow 5 enters or exits through these flow openings 8, 9. The flow openings 8, 9 extend across all spacers 3. Accordingly, the exhaust gas flow 5 reaches the area of the folds of the membrane 7 into which the spacers 3 are projecting.

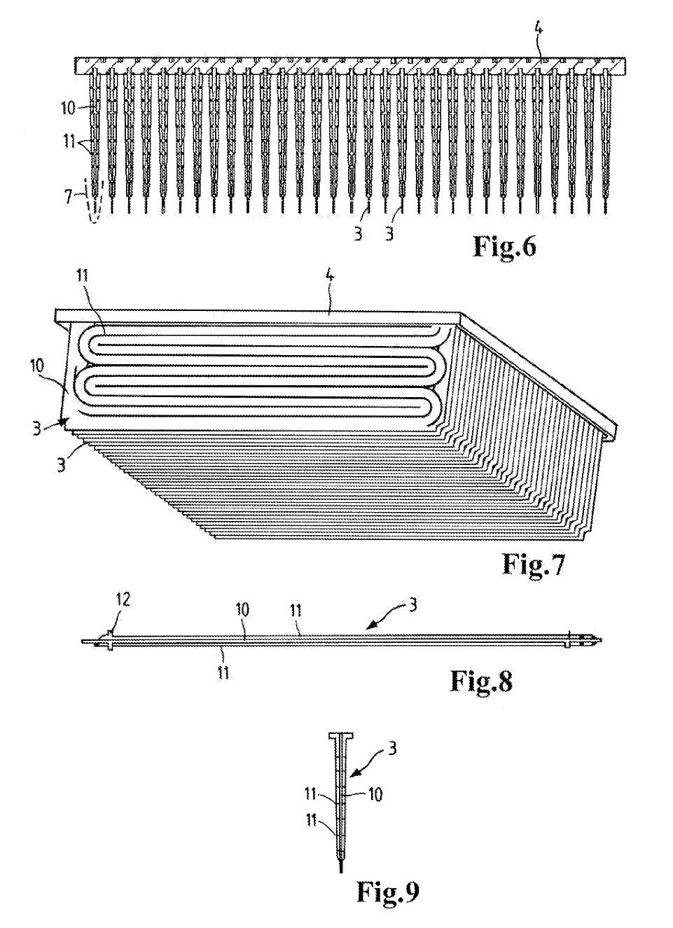

As can be seen in FIGS. 4 to 9, the spacers 3 each comprise a plate-shaped base support 10 and transverse profiles 11 which extend transversely to the plane of the base support 10 at both sides. The transverse profiles 11 secured on the base support 10 form a meander structure so that at both lateral surfaces of the base support 10 a meander-like flow channel is formed, respectively, through which the exhaust gas flow 5 is guided (FIGS. 5, 7). The meander-shaped structure on the lateral surfaces of the base support 10 prolongs the flow path of the exhaust gas flow between inlet and outlet and thus prolongs the duration of moisture exchange.

As can be seen in FIG. 4, the transverse profiles 11 at the base support 10 of the spacers 3 have a width that decreases in the direction of the fold base which takes into the account the tapering fold width. The transverse profiles 11 extend at both sides of the base support 10. The free end faces of the transverse profiles 11 keep the contacting side of the membrane 7 at a distance and impart the fold shape to the membrane 7.

As can be seen in FIG. 8, a sealing element 12 can be attached by injection molding in the area of the end face of a spacer 3; the sealing element 12 provides a satisfactory flow-tight sealing action relative to a frame or housing part of the housing after insertion of the spacer.

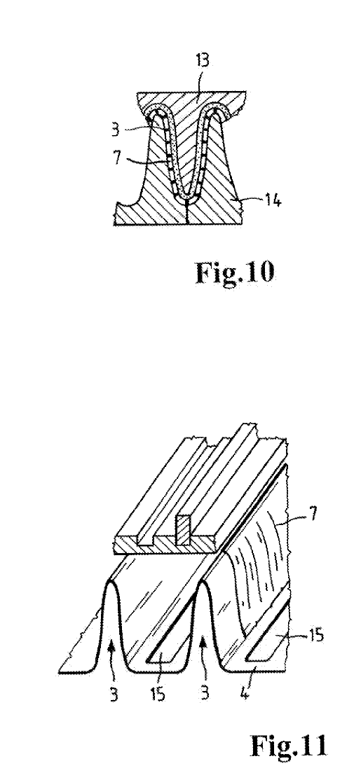

As can be seen in FIG. 10, the edge area of the membrane 7 can be flow-tightly sealed by means of two frame parts 13 and 14 which are meshing comb-like with each other and follow the folds of the membrane 7. The frame parts 13 and 14 are components of the housing.

At least one of the components 13 and 14 can also be a sealing element that is injection-molded or potted onto the edge of the membrane 7 in order to obtain a flow-tight closure.

In FIG. 11, an embodiment variant of the base plate 4 is illustrated which is a component of the housing. Insertion openings 15 for the insertion of spacers are introduced into the base plate 4. Between two insertion openings 15, respectively, there is a spacer 3 which is monolithically embodied together with the base plate 4. Accordingly, half of the spacers 3 are monolithically formed together with the base plate 4, the other half is introduced through the insertion openings 15. The spacers to be inserted are either individual parts or can be secured on a common support frame and introduced through the insertion openings 15.

While specific embodiments of the invention have been shown and described in detail to illustrate the inventive principles, it will be understood that the invention may be embodied otherwise without departing from such principles.

What is claimed is:

1. A humidifier comprising:
a housing;
at least one water-permeable membrane arranged in the housing and comprising first and second opposed sides, wherein a first gas stream having a first moisture contents is guided along the first opposed side through the humidifier and a second gas stream having a second moisture contents is guided along the second opposed side through the humidifier, wherein the first moisture contents is higher than the second moisture contents;
wherein the at least one water-permeable membrane is folded and comprises folds.

2. The humidifier according to claim 1, further comprising spacers inserted into the folds of the at least one water-permeable membrane.

3. The humidifier according to claim 2, wherein the spacers are inserted only into the folds exposed to the first gas stream or into the folds exposed to the second gas stream.

4. The humidifier according to claim 2, wherein the spacers extend across a length of the folds.

5. The humidifier according to claim 2, further comprising a base plate, wherein the spacers each are a rectangular insertion part that is secured on the base plate.

6. The humidifier according to claim 5, wherein the base plate comprises insertion openings and the spacers are inserted in the insertion openings.

7. The humidifier according to claim 2, wherein the spacers each comprise a base support comprising laterally projecting transverse profiles, wherein the at least one water-permeable membrane is supported on the laterally projecting transverse profiles.

8. The humidifier according to claim 7, wherein the transverse profiles form a meander-shaped flow channel along the base support.

9. The humidifier according to claim 2, wherein the spacers comprise end faces and sealing elements provided at the end faces.

10. The humidifier according to claim 1, further comprising a support grid resting on at least one of the first and second opposed sides of the at least one water-permeable membrane, wherein the support grid extends at least approximately across an entire surface of said at least one of the first and second opposed sides.

11. The humidifier according to claim 1, further comprising support grids resting on the first and second opposed sides of the at least one water-permeable membrane, wherein the support grids extend at least approximately across an entire surface of the first and second opposed sides, respectively.

12. The humidifier according to claim 1, further comprising two comb-shaped frame parts meshing with each other, wherein an edge of the at least one water-permeable membrane is secured between the two comb-shaped frame parts for providing an edge-side sealing action of the at least one water-permeable membrane.

13. The humidifier according to claim 1, further comprising a sealing element arranged at an end face of the at least one water-permeable membrane for providing an edge-side sealing action.

14. The humidifier according to claim 13, wherein the sealing element is injection-molded or potted onto the at least one water-permeable membrane.

15. A fuel cell with a humidifier according to claim 1.
